(19) United States
(12) Patent Application Publication
(10) Pub. No.: US 2015/0062173 A1
(43) Pub. Date: Mar. 5, 2015

(54) Method to Visualize Semantic Data in Contextual Window

(71) Applicant: International Business Machines Corporation, Armonk, NY (US)

(72) Inventors: Jennifer L. Milam, Austin, TX (US); Eric W. Leong, Austin, TX (US); Pamela A. Nesbitt, Austin, TX (US); Jonathan W. Stoecker, Austin, TX (US)

(73) Assignee: International Business Machines Corporation, Armonk, NY (US)

(21) Appl. No.: 14/015,767

(22) Filed: Aug. 30, 2013

(51) Int. Cl. G09G 5/377

(52) U.S. Cl. CPC G09G 5/377; G09G 2340/12
USPC 345/635; 345/634

(57) ABSTRACT

A system and a computer program product for displaying contextual semantic data in a graphical overlay includes a processor activating a first lens corresponding to a first domain, activating at least one first domain context within the first lens, and responsive to activating the at least one first domain context within the first lens, displaying the first domain context within the first lens. At least one second domain context is activated and displayed throughout the entire graphical overlay while simultaneously displaying the at least one first domain context within the first lens. Alternatively, the at least one second domain context is displayed within an activated second lens, which corresponds to a second domain, while simultaneously displaying the at least one first domain context within the first lens. By simultaneously displaying the first and second domain contexts, a cross-domain interaction between the first and second domains is identified.

### CROSS REFERENCE TO RELATED APPLICATIONS

The present disclosure is related to the subject matter of commonly assigned, co-pending application Ser. No. ______ (Atty. Doc. No. AUS920130118US1) and co-pending application Ser. No. ______ (Atty. Doc. No. AUS920130236US1), filed on even date herewith.

### BACKGROUND

1. Technical Field

The present disclosure generally relates to computer systems and in particular to computer-implemented methods of visualizing semantic data in a contextual window.

2. Description of the Related Art

The management and operation of cities and/or enterprises is a challenging task, particularly with the ever-increasing size and number of entities within them. In order to make well-informed decisions regarding city and/or enterprise operations, relationships between and among entities, such as buildings, equipment, etc., and related information such as maintenance history and schedules, must be available and understood. The modeling of complex relationships among such entities is challenging and becomes more difficult as the complexities of cities/enterprises increase. Semantic models have been used to model the relationships among city/enterprise entities, and specifically have been used to describe linkages between and among different sets of data across various entities. However, in order to learn anything about the relationships and associations defined by a semantic model, a user must construct a set of fairly complex queries (e.g., structured query language (SQL) queries) in order to retrieve desired relational information about the entities.

### BRIEF SUMMARY

Disclosed are a method, a system and a computer program product for displaying contextual semantic data in a graphical overlay.

The method includes displaying the graphical overlay on a spatial rendering of data, where the graphical overlay includes a spatial rendering of data including one of a geospatial map, a logical map, and a system map. A first lens, which corresponds to a first domain, is activated. The first domain includes at least one first domain context. The first lens is overlaid on a first region of the graphical overlay, and the at least one first domain context is activated within the first lens. In response to activating the at least one first domain context within the first lens, the at least one first domain context, which is a visual representation of a first domain semantic model, is displayed within the first lens. A second domain, including at least one second domain context, is activated. The at least one second domain context, which is a visual representation of a second domain semantic model, may be displayed throughout the entire graphical display while simultaneously displaying the at least one first domain context within the first lens. Alternatively, a second lens which corresponds to the second domain is activated, and the second lens is overlaid on a second region of the graphical overlay. The at least one second domain context may be activated within the second lens. In response to activating the at least one second domain context within the second lens, the at least one second domain context is displayed within the second lens while simultaneously displaying the at least one first domain context within the first lens. In response to simultaneously displaying visual representations of the first and second domain semantic models, a cross-domain interaction between the first and second domains can be identified.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 provides a block diagram representation of an example data processing system within which the disclosure can be practiced, according to one embodiment;

FIG. 2 illustrates a block diagram representation of an example operations environment in accordance with one embodiment;

FIG. 3 is a graphical overlay illustrating at least one first domain context within a first lens according to one embodiment;

FIG. 4 is a graphical overlay illustrating at least one first domain context within a first lens and at least one second domain context within a second lens, in accordance with one embodiment;

FIG. 5 is a graphical overlay illustrating at least one first domain context within a first lens and at least one second domain context within a second lens, in accordance with an alternative embodiment;

FIG. 6 is a graphical overlay illustrating at least one first domain context within a first lens and at least one second domain context within a second lens, in accordance with yet another embodiment;

FIG. 7 is a graphical overlay illustrating at least one first domain context within a first lens and at least one second domain context throughout the graphical overlay, in accordance with one embodiment;

FIG. 8 is a graphical overlay illustrating a first set of lenses overlaid on a first region of the graphical overlay and a second set of lenses overlaid on a second region of the graphical overlay, in accordance with one embodiment;

FIG. 9 is a flow chart illustrating a method for displaying at least one first domain context within a lens and at least one second domain context throughout an entire graphical overlay, in accordance with one embodiment;

FIG. 10 is a flow chart illustrating a method for displaying at least one first domain context within a first lens and at least one second domain context within a second lens, in accordance with one embodiment; and

FIG. 11 is a flow chart illustrating a method for displaying at least one first domain context within a first set of lenses and at least one second domain context within a second set of lenses, in accordance with various embodiments.

### DETAILED DESCRIPTION

The illustrative embodiments provide a method, system, and computer program product for displaying a graphical overlay on a spatial rendering of data. A first lens corresponding to a first domain is activated, and at least one first domain context is activated within the first lens. Responsive to activating the at least one first domain context within the first lens, the at least one first domain context is displayed within the first lens. At least one second domain context may be activated and displayed throughout the entire graphical display while simultaneously displaying the at least one first domain context within the first lens. Alternatively, the at least one second domain context may be displayed within an activated second lens, which corresponds to a second domain, while simultaneously displaying the at least one first domain context within the first lens. By simultaneously displaying the at least one first and second domain contexts, which are visual representation of first and second domain semantic models, a cross-domain interaction between the first and second domains can be identified.

In the following detailed description of exemplary embodiments of the disclosure, specific exemplary embodiments in which the disclosure may be practiced are described in sufficient detail to enable those skilled in the art to practice the disclosure, and it is to be understood that other embodiments may be utilized and that logical, architectural, programmatic, mechanical, electrical and other changes may be made without departing from the spirit or scope of the present disclosure. The following detailed description is, therefore, not to be taken in a limiting sense, and the scope of the present disclosure is defined by the appended claims and equivalents thereof.

In the following detailed description, numerous specific details such as specific method orders, structures, elements, and connections have been set forth. It is to be understood however that these and other specific details need not be utilized to practice embodiments of the present disclosure. In other circumstances, well-known structures, elements, or connections have been omitted, or have not been described in particular detail in order to avoid unnecessarily obscuring this description.

References within the specification to “one embodiment,” “an embodiment,” or “embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

It is understood that the use of specific component, device and/or parameter names (such as those of the executing utility/logic described herein) are for example only and not meant to imply any limitations on the disclosure. The disclosure may thus be implemented with different nomenclature/terminology utilized to describe the components/devices/parameters herein, without limitation. Each term utilized herein is to be given its broadest interpretation given the context in which that terms is utilized.

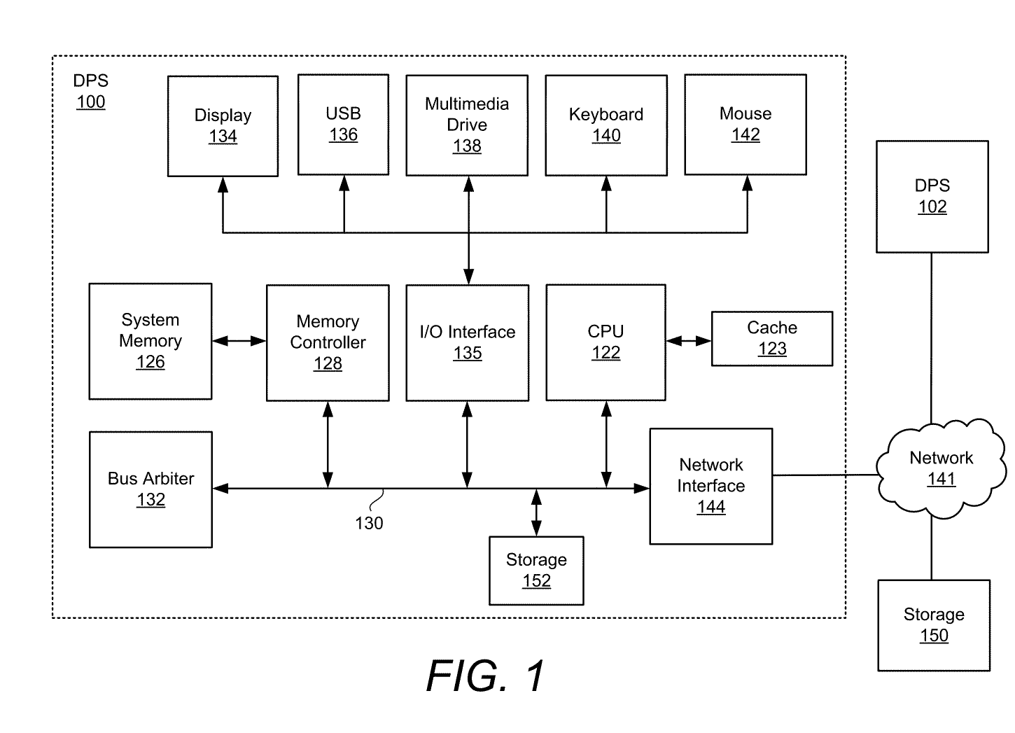

Those of ordinary skill in the art will appreciate that the hardware components and basic configuration depicted in the presented figures may vary. For example, the illustrative components within the data processing system (DPS 100, FIG. 1) are not intended to be exhaustive, but rather are representative to highlight essential components that are utilized to implement the present disclosure. For example, other devices/components may be used in addition to or in place of the hardware depicted. The depicted example is not meant to imply architectural or other limitations with respect to the presently described embodiments and/or the general disclosure. The data processing system depicted in FIG. 1 may be, for example, an IBM eServer pSeries system, a product of International Business Machines Corporation in Armonk, N.Y., running the Advanced Interactive Executive (AIX) operating system or LINUX operating system.

With reference now to the figures, and beginning with FIG. 1, there is depicted a block diagram representation of an example data processing system (DPS), as utilized within one embodiment. The data processing system is described as having features common to a server computer. However, as used herein, the term “data processing system,” is intended to include any type of computing device or machine that is capable of receiving, storing and running a software product including not only computer systems, but also devices such as communication devices (e.g., routers, switches, pagers, telephones, electronic books, electronic magazines and newspapers, etc.) and personal and home consumer devices (e.g., handheld computers, Web-enabled televisions, home automation systems, multimedia viewing systems, etc.).

FIG. 1 and the following discussion are intended to provide a brief, general description of an exemplary data processing system adapted to implement the described embodiments. While embodiments will be described in the general context of instructions residing on hardware within a data processing system, those skilled in the art will recognize that embodiments may be implemented in a combination of program modules running in an operating system. Generally, program modules include routines, programs, components, and data structures, which perform particular tasks or implement particular abstract data types. The described features of the disclosure may also be practiced in distributed computing environments where tasks are performed by remote processing devices that are linked through a communications network. In a distributed computing environment, program modules may be located in both local and remote memory storage devices.

A DPS, such as DPS 100, can include at least one processing unit (CPU) 122, a system memory 126 coupled to a memory controller 128, and a system interconnect fabric 130 that couples memory controller 128 to CPU 122 and other components of DPS 100. System interconnect fabric 130 in an embodiment can be an address and data bus. Commands on system interconnect fabric 130 are communicated to various system components under the control of bus arbiter 132.

DPS 100 can further include cache memory 123 for high speed storage of frequently used data. Cache memory 123 can be connected to or communicatively coupled with CPU 122. While cache memory 123 is shown operatively connected to CPU 122, cache memory 123 can also operatively be a part of system memory 126.

DPS 100 further includes computer readable storage media, such as one or more multimedia drives 138, including for example hard disk drives. Multimedia drives 138 provide non-volatile storage for DPS 100. DPS 100 also includes one or more user interface devices, which allow a user to provide input and receive output from DPS 100. For example, user interface devices can include displays 134, universal serial bus (USB) ports 136, keyboards 140, and pointing devices such as a mouse 142. Multimedia drives 138 and the various user interface devices can be communicatively coupled to system interconnect fabric 130 by an input-output (I/O) interface 135. Although the description of computer readable storage media above refers primarily to a hard disk, it should be appreciated by those skilled in the art that other types of media which are readable by a computer, such as removable magnetic disks, CD-ROM disks, magnetic cassettes, flash memory cards, digital video disks, Bernoulli cartridges, and other later-developed hardware, may also be used in the exemplary computer operating environment.

DPS 100 also comprises storage 152, within which data/instructions/code may be stored. Storage 152 is communicatively coupled to system interconnect fabric 130. In addition to the above described hardware components of DPS 100, various features of the disclosure are completed via software (or firmware) code or logic stored within system memory 126 or other storage (e.g., storage 152) and executed by CPU 122. In one embodiment, data/instructions/code from storage 152 populates the system memory 126, which is also coupled to system interconnect fabric 130 via the memory controller 128.

DPS 100 may also operate in a networked environment using logical connections to one or more remote computers or data processing systems, such as DPS 102. DPS 102 may be a computer, a server, a router or a peer device and typically includes many or all of the elements described relative to DPS 100. In a networked environment, program modules employed by DPS 100, or portions thereof, may be stored in a remote memory storage device 150. The logical connections depicted in FIG. 1 can include connections over a network 141. In an embodiment, network 141 may be a local area network (LAN). In alternative embodiments, network 141 may include a wide area network (WAN). DPS 100 is connected to network 141 through an input/output interface, such as a network interface 144. It will be appreciated that the network connections shown are exemplary and other means of establishing a communications link between the computers may be used.

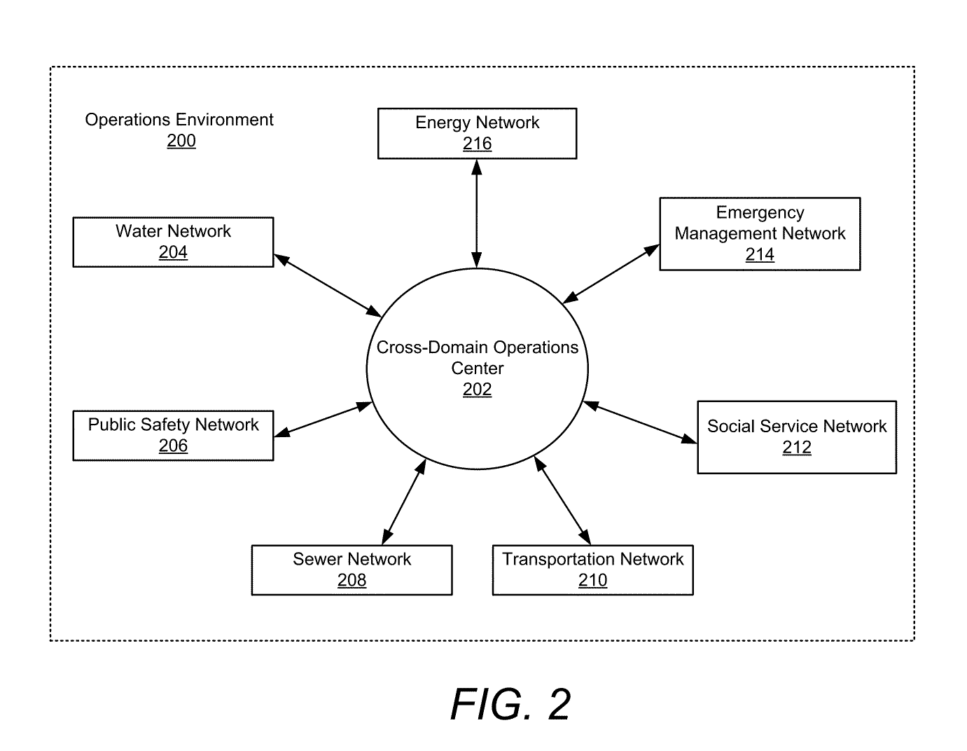

FIG. 2 illustrates a block diagram representation of an example operations environment 200 in accordance with one embodiment. The operations environment 200, which may be for example a city, includes a plurality of domain-specific operations centers, illustrated in FIG. 2 as a water network 204, a public safety network 206, a sewer network 208, a transportation network 210, a social services network 212, an emergency management network 214, and an energy network 216. As used herein, the term “domain,” is intended to identify all of the infrastructure, applications, and data related to a particular one of the networks identified by each of the plurality of domain-specific operations centers (i.e., water, public safety, sewer, transportation, social service, emergency management, and energy). Each of water network 204, public safety network 206, sewer network 208, transportation network 210, social services network 212, emergency management network 214, and energy network 216 are communicatively coupled to a cross-domain operations center 202. In practice, the cross-domain operations center 202 provides a holistic view of the operations environment 200 by serving as a centralized hub through which information is accessed and shared across each of the specific domains within the operations environment 200. Thus, data and information obtained from the various domains, as well as from other data sources, can be collectively analyzed and presented so as to enable well-informed decisions regarding the management and operations of domains within the operations environment 200.

To facilitate the collection and analysis of data/information from various sources, the illustrated operations environment 200 also includes domain-specific semantic models, which contain all the information related to a particular domain, including specifications, maintenance records/schedule, failure history, composition, and cost, among others. Moreover, in various embodiments, the operations environment 200 includes a reference semantic model which provides a linkage between/among the domain-specific semantic models (i.e., between/among multiple data sets), and can be used to model complex relationships between and among the various domain entities, for example in a city or enterprise, such as devices, equipment, buildings, infrastructure, etc. Thus, the reference semantic model can be used to model the relationship of such domain entities to one another and to other non-tangible items mentioned above such as maintenance records/schedule, failure history, composition, and cost, among others. By modeling these relationships and associations, specific interactions between and among domain entities may be better understood. However, in order to extract this information from the semantic models, complex queries (e.g., structured query language (SQL) queries) are used to retrieve the desired relational information. Furthermore, in various embodiments, in addition to data obtained via one or more semantic models as mentioned above, data within the operations environment 200 may include data from one or more of a plurality of other data sources such as historical data, projected data, user inputted data, web content, streaming content, data obtained from a local database, and data obtained from a remote database, among others. Thus, the present disclosure provides a solution that addresses a need for an intuitive, singular way to render semantic data geospatially or in the context of an entire system or set of systems.

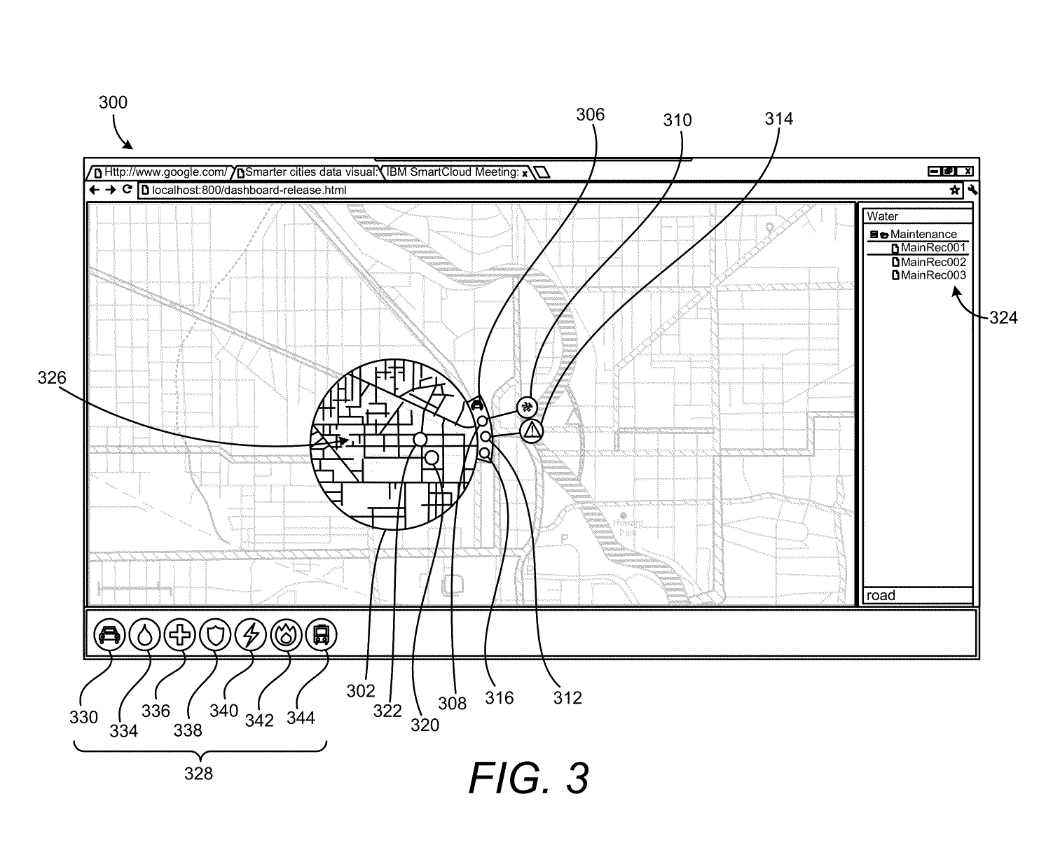

FIG. 3 illustrates a graphical overlay on a spatial rendering of data according to one embodiment. In some embodiments, as illustrated in FIG. 3, the graphical overlay 300 includes a geospatial map 300 which further includes a plurality of streets. Thus, as described herein, the geospatial map 300 may represent a city and/or region wherein one or more of the embodiments are practiced. Moreover, the embodiments discussed below with reference to FIGS. 3-8 can be accomplished within an operations environment, such as the operations environment 200 of FIG. 2. Further, the embodiments discussed herein can be used for various other applications including for example, visualization of social networks, internet of things, etc. Returning to FIG. 3, there is illustrated a lens 302 including at least one first domain context. As used herein, the term “context” is used to identify data/information related to a particular aspect of a given domain. Considering the example of the lens 302, which corresponds to a transportation domain as indicated by icon 306, a plurality of contexts related to the transportation domain may include road maintenance records/schedules, areas of traffic congestion, areas where traffic accidents have occurred, roadway costs, predicted traffic, and other alerts/warnings which may be defined by the operations environment 200 and/or by the user. The data corresponding to the various contexts listed above may include data from one or more of a plurality of data sources such as semantic model data, historical data, projected data, user inputted data, web content, streaming content, data obtained from a local database, and data obtained from a remote database, among others. Moreover, the above list of exemplary contexts is merely illustrative, and not meant to be limiting in any way. Those skilled in the art will recognize many other contexts which may be included within this list, as well as other contexts which may be included as parts of other domains.

The lens 302 is activated by selection of a transportation network icon 330 (e.g., by a mouse click and hold or via an interactive touch screen) and overlaying the icon on a region of the graphical overlay 300 (e.g., by a mouse drag or via an interactive touch screen). The lens 302 thus corresponds to a transportation network domain, and is one of a plurality of domains accessible via a domain selection panel 328. Other domains accessible via the domain selection panel 328 include a water management network 334, a healthcare network 336, a public safety network 338, an energy network 340, a fire network 342, and a public services network 344. The domains shown as accessible via the domain selection panel 328 are for illustrative purposes only, and may, in other embodiments, include domains not listed here. For example, the domains can include those shown in FIG. 2, such as a sewer network 208, a social services network 212, and an emergency management network 214, as well as other domains such as an environmental network and a buildings network, among others. The choice of domains accessible via the domain selection panel 328 may be dependent on specific application needs, such as the needs and/or requirements of the specific city or enterprise within which one or more of the embodiments described herein is being deployed.

Context visibility, which in some embodiments is equivalently used to describe context activation, within the lens 302 may be controlled by way of interactive icons 308, 312, 316. In some embodiments, as discussed further below, various contexts within the lens 302 are accessible by manipulation of the lens 302. As used herein, the term “manipulation of the lens” may include one or more of a variety of actions related to the lens 302 such as lens activation, interfacing with one or more of the interactive icons 308, 312, 316, lens translations (e.g., across the graphical overlay 300), and lens rotation, among others. As shown in FIG. 3, icon 308 is expanded to icon 310 (e.g., by a mouse hover and/or click or via an interactive touch screen), and icon 312 is similarly expanded to icon 314. In this example, icon 308/310 indicates a road maintenance records/schedules context, and icon 312/314 indicates a transportation alerts/warnings context. Activation of at least one of the transportation domain contexts results in the at least one activated transportation domain context being displayed within the lens 302. As indicated by arrow 326, elements of the transportation domain related to the at least one activated transportation domain context are highlighted within the area circumscribed by the lens 302. In some embodiments, upon activation of the lens 302, a default transportation domain context is activated. In other embodiments, upon activation of the lens 302, no domain contexts are activated by default, and instead any activated contexts are user-activated. By way of example, consider that both the road maintenance records/schedule context (represented by icons 308/310) and the transportation alerts/warnings context (represented by icons 312/314) are activated. In various embodiments, activation of each of the road maintenance records/schedule context and the transportation alerts/warnings context results in obtaining data related to the road maintenance records/schedule context and the transportation alerts/warnings context, respectively. These data are obtained from one or more of a plurality of data sources and including, for example, semantic model data, historical data, projected data, user inputted data, web content, streaming content, data obtained from a local database, and data obtained from a remote database, among others. Further, in this example, activation of the road maintenance records/schedule context results in an icon 320 displayed within the lens 302 on the graphical overlay 300 which corresponds to a section of roadway that is scheduled for repair within a pre-defined time-frame. Further details regarding repair/maintenance records may also be made available for inspection via side panel 324.

Activation of the transportation alerts/warnings context results in an icon 322 displayed within the lens 302 on the graphical overlay 300, where icon 322 corresponds to an area of traffic congestion. Within the context of the various embodiments described herein, the display of a domain context within a lens is equivalently a visual representation of a semantic model for that particular domain. Thus, as shown in FIG. 3, displaying at least one of the road maintenance records/schedule context and the transportation alerts/warnings context within the lens 302 corresponds to displaying a visual representation of a transportation domain semantic model within the lens 302.

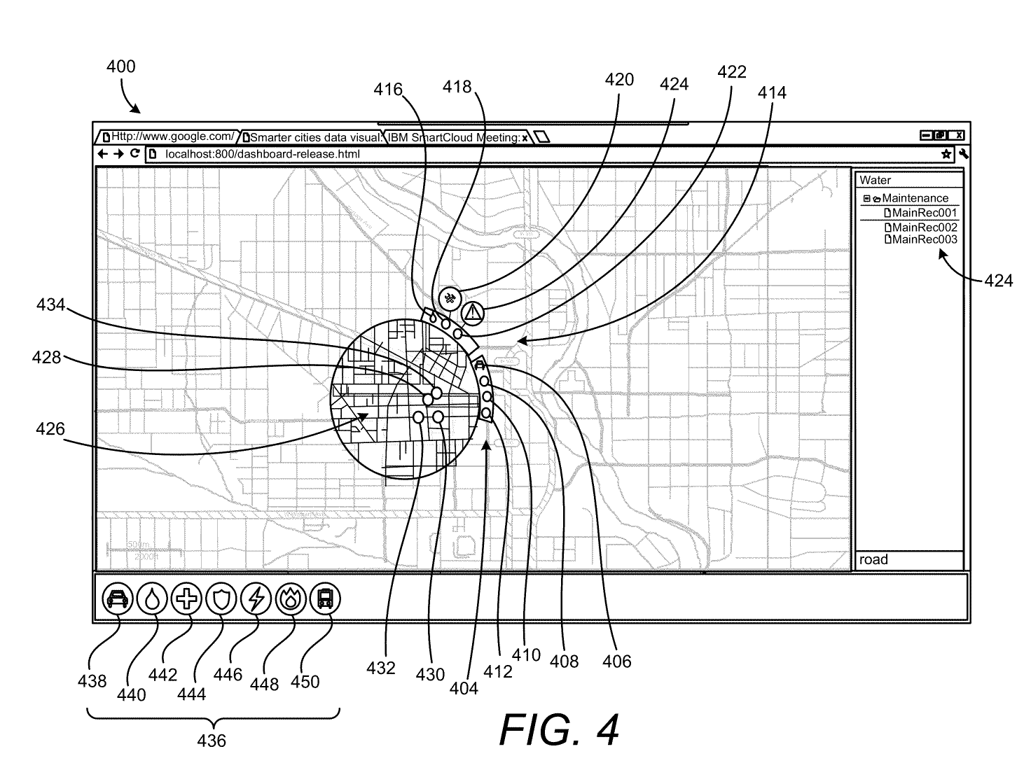

FIG. 4 is a graphical overlay illustrating a first lens 404 including at least one first domain context and a second lens 414 including at least one second domain context, in accordance with one embodiment. The first lens 404 corresponds to a transportation network domain as indicated by icon 406 and the second lens corresponds to a water management network domain as indicated by icon 416. The first lens 404 is activated by selection of a transportation network icon 438 via a domain selection panel 436 and overlaid on a region of the graphical overlay 400. In some embodiments, the second lens 414 is activated by selection of a water management network icon 440 via the domain selection panel 436 and overlaid on the same region of the graphical overlay 400 as the first lens 404 such that the first lens 404 and the second lens 414 are in a fully overlapping spatial relation to each other. In other embodiments, as discussed below, the first lens 404 and the second lens 414 may be in one of a partially overlapping and non-overlapping spatial relation to each other.

Visibility of various transportation domain contexts within the lens 404 is controlled by way of interactive icons 408, 410, 412, and visibility of water management domain contexts within the second lens 414 is controlled by way of interactive icons 418, 422. As shown in FIG. 4, icon 418 is expanded to icon 420 (e.g., by a mouse hover and/or click or via an interactive touch screen), and icon 422 is similarly expanded to icon 424. In some embodiments, icon 418/420 indicates a water pipe maintenance records/schedules context, and icon 422/424 indicates a water management alerts/warnings context. Activation of at least one of the transportation domain contexts results in the at least one activated transportation domain context being displayed within the first lens 404, as indicated by arrow 426, where elements of the transportation domain related to the at least one activated transportation domain context are highlighted within the area circumscribed by the first lens 404. Similarly, activation of at least one of the water management domain contexts results in the at least one activated water management domain context being displayed within the second lens 414, as indicated by arrow 426, where elements of the water management domain related to the at least one activated water management domain context are highlighted within the area circumscribed by the second lens 414. In some embodiments, upon activation of either of the first or second lenses 404, 414, at least one of a default transportation and water management domain context is activated. In other embodiments, upon activation of either of the first or second lenses 404, 414, no domain contexts are activated by default, and instead any activated contexts are user-activated.

As an example, consider that both the road maintenance records/schedule context (represented by icon 408) and the transportation alerts/warnings context (represented by icon 410) are activated, as described with reference to FIG. 3. Specifically, activation of the road maintenance records/schedule context results in an icon 430 displayed within the first lens 404 on the graphical overlay 400 which corresponds to a section of roadway that is scheduled for repair within a pre-defined time-frame, and activation of the transportation alerts/warnings context results in an icon 428 displayed within the first lens 404 on the graphical overlay 300 which corresponds to an area of traffic congestion. Now, consider that both the water pipe maintenance records/schedule context (represented by icons 418/420) and the water management alerts/warnings context (represented by icons 422/424) are activated. As a result, activation of the water pipe maintenance records/schedule context results in an icon 432 displayed within the lens 414 on the graphical overlay 400 which corresponds to a section of water pipe that is due for repair within a pre-defined time-frame. Additionally, activation of the water management alerts/warnings context results in an icon 434 displayed within the second lens 414 on the graphical overlay 400 which corresponds to an area of a slow water leak in one of the pipes. The slow water leak in turn appears to have caused a sinkhole in the adjacent roadway, and the sinkhole can be identified as a causal factor in the area of traffic congestion indicated by icon 428. As discussed above, displaying at least one of the road maintenance records/schedule context and the transportation alerts/warnings context within the first lens 404 corresponds to displaying a visual representation of a transportation domain semantic model within the first lens 404. Also, displaying at least one of the water pipe maintenance records/schedule context and the water management alerts/warnings context within the second lens 414 corresponds to displaying a visual representation of a water management domain semantic model within the second lens 414. Thus, by simultaneously displaying the visual representations of the transportation domain and water management domain semantic models, a cross-domain interaction between the transportation domain and the water management domain can be identified based on visual patterns of semantic data between the transportation and water management domain semantic models, as represented by the visual contextual data displayed within each of the first and second lenses 404, 414. Further, as a result of identifying such cross-domain interactions, well-informed decisions regarding the management and operations of the affected domains within the city and/or region represented by the graphical overlay 400 (i.e., the operations environment) can be made.

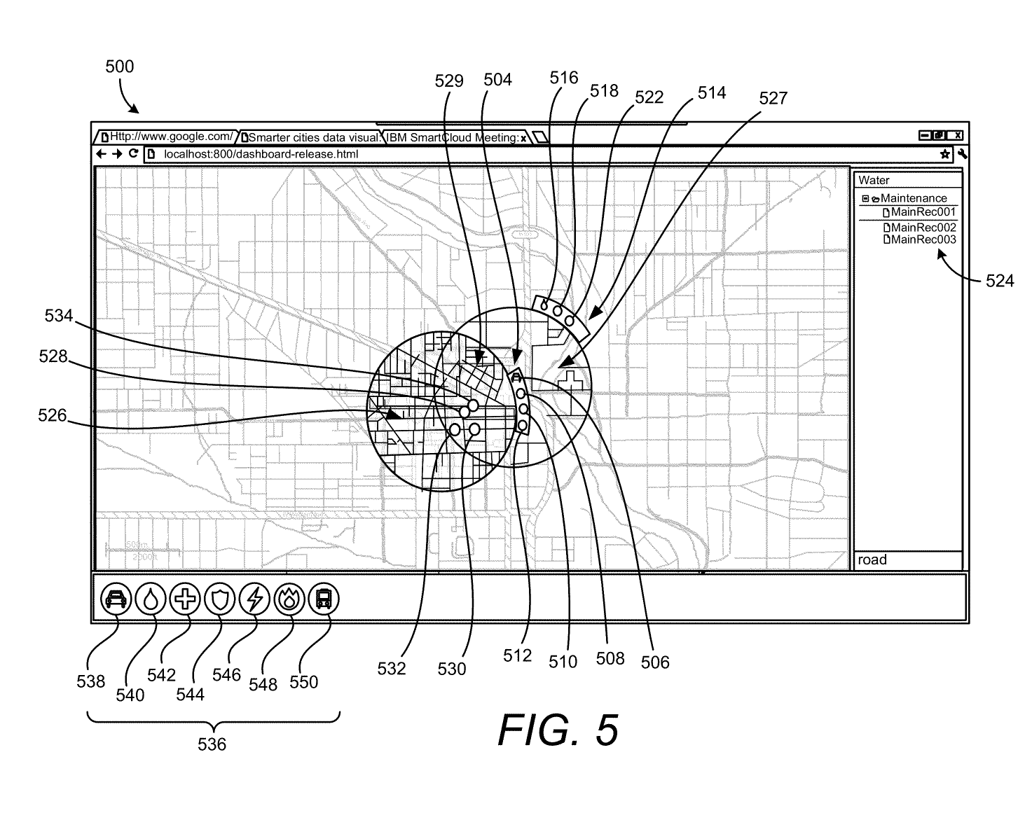

FIG. 5 is a graphical overlay illustrating a first lens 504 including at least one first domain context and a second lens 514 including at least one second domain context, in accordance with some embodiments. Similar to FIG. 4, the first lens 504 corresponds to a transportation network domain as indicated by icon 506 and the second lens corresponds to a water management network domain as indicated by icon 516. The first lens 504 is activated by selection of a transportation network icon 538 via a domain selection panel 536 and overlaid on a first region of the graphical overlay 500. The second lens 514 is activated by selection of a water management network icon 540 via the domain selection panel 536 and overlaid on a second region of the graphical overlay 500 such that the first lens 504 and the second lens 514 are in a partially overlapping spatial relation to each other. In other embodiments, as described herein, the first lens 504 and the second lens 514 may be in one of a fully overlapping and non-overlapping spatial relation to each other.

Visibility of various transportation domain contexts within the lens 504 is controlled by way of interactive icons 508, 510, 512, and visibility of water management domain contexts within the second lens 514 is controlled by way of interactive icons 518, 522. Activation of at least one of the transportation domain contexts results in the at least one activated transportation domain context being displayed within the first lens 504, as indicated by arrow 526, and activation of at least one of the water management domain contexts results in the at least one activated water management domain context being displayed within the second lens 514, as indicated by arrow 527. By way of example, consider that both a road maintenance records/schedule context (represented by icon 508) and a transportation alerts/warnings context (represented by icon 510) are activated, resulting in icons 530 and 528 displayed within the first lens 504 on the graphical overlay 500. Also, consider that both the water pipe maintenance records/schedule context (represented by icon 518) and the water management alerts/warnings context (represented by icon 522) are activated, resulting in icons 532 and 534 displayed within the second lens 514 on the graphical overlay 500. Although the first lens 504 and the second lens 514 are in a partially overlapping spatial relation to one another, as compared to the fully overlapping spatial relation shown in FIG. 4, a fully overlapping lenses region, indicated by arrow 529, displays the visual representations of both the transportation domain and water management domain semantic models. The fully overlapping lenses region enables a cross-domain interaction between the transportation domain and the water management domain to be identified (e.g., an area of a slow water leak in one of the pipes appears to have caused a sinkhole in the adjacent roadway, which is identified as causing traffic congestion in the adjacent roadway) within the fully overlapping lenses region. And as a result of identifying the cross-domain interactions, the cross-domain interaction also enables well-informed decisions to be made regarding the management and operations of the affected domains within the city and/or region represented by the graphical overlay 500 (i.e., the operations environment).

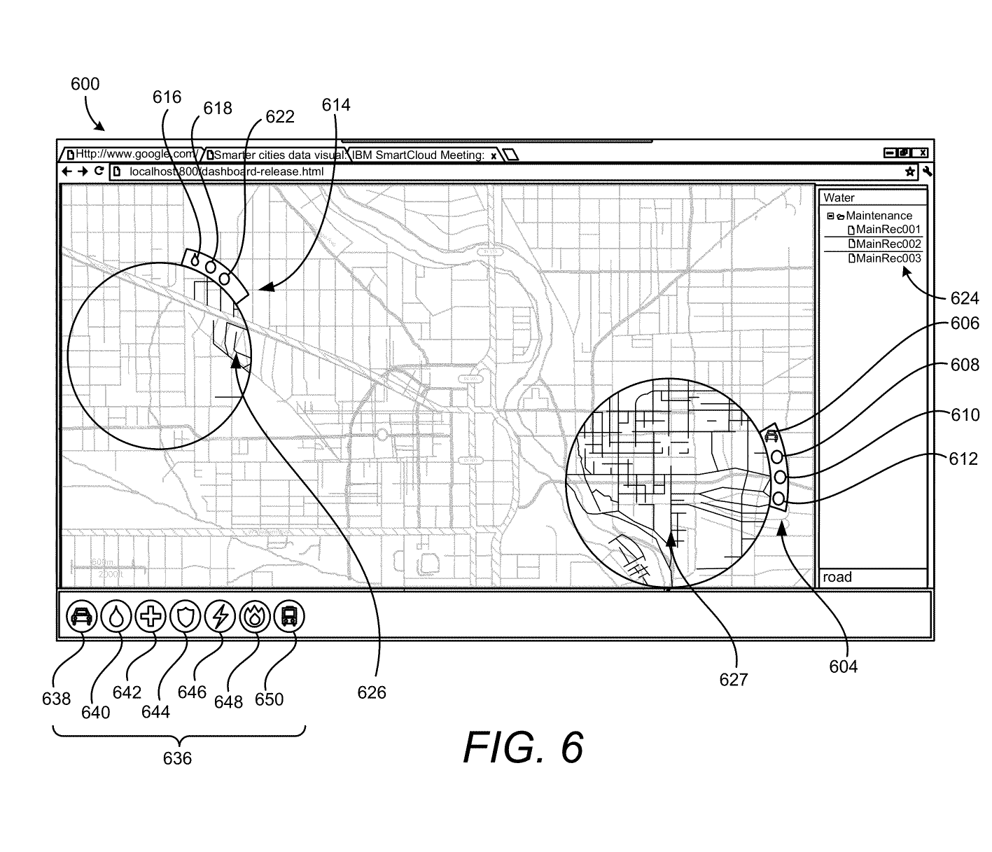

FIG. 6 is a graphical overlay illustrating a first lens 604 including at least one first domain context and a second lens 614 including at least one second domain context, in accordance with some embodiments. As in FIGS. 4-5, the first lens 604 corresponds to a transportation network domain as indicated by icon 606 and the second lens corresponds to a water management network domain as indicated by icon 616. The first lens 604 is activated by selection of a transportation network icon 638 via a domain selection panel 636 and overlaid on a first region of the graphical overlay 600. The second lens 614 is activated by selection of a water management network icon 640 via the domain selection panel 636. The second lens 614 is overlaid on a second region of the graphical overlay 600 such that the first lens 604 and the second lens 614 are in a non-overlapping spatial relation to each other. In other embodiments, as described above, the first lens 604 and the second lens 614 may be in one of a fully overlapping and partially overlapping spatial relation to each other.

Visibility of various transportation domain contexts within the lens 604 is controlled by way of interactive icons 608, 610, 612, and visibility of water management domain contexts within the lens 614 is controlled by way of interactive icons 618, 622. Activation of at least one of the transportation domain contexts results in the at least one activated transportation domain context being displayed within the first lens 604, as indicated by arrow 627, and activation of at least one of the water management domain contexts results in the at least one activated water management domain context being displayed within the second lens 614, as indicated by arrow 626. In the example of FIG. 6, consider that at least one of a road maintenance records/schedule context (represented by icon 608) and a transportation alerts/warnings context (represented by icons 610) are activated; however, with no icons displayed within the first lens 604, a user may infer that there are currently no messages related to road maintenance and/or other transportation alerts/warnings that require attention. Similarly, consider that at least one of a water pipe maintenance records/schedule context (represented by icon 618) and a water management alerts/warnings context (represented by icon 622) are activated; however, with no icons displayed within the second lens 614, a user may infer that there are currently no messages related to water pipe maintenance and/or other water management alerts/warnings that require attention.

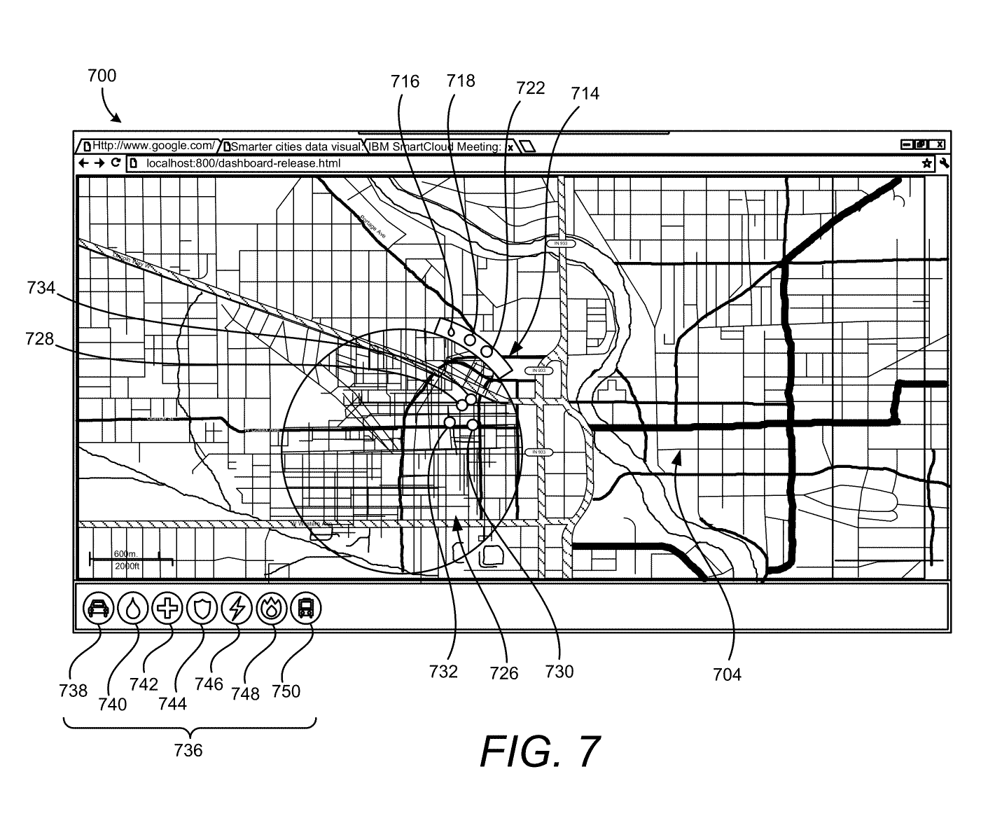

FIG. 7 is a graphical overlay illustrating a lens 714 including at least one first domain context, and at least one second domain context which is displayed throughout the entire graphical overlay 700, as indicated by arrow 704, in accordance with one embodiment. In the example of FIG. 7, lens 714 corresponds to a water management network domain as indicated by icon 716 and the at least one second domain context corresponds to a transportation network domain. In some embodiments, the at least one second domain context is activated and displayed throughout the entire graphical overlay 700 by selection of a transportation network icon 738 (e.g., by a mouse click or via an interactive touch screen) via the domain selection panel 736. The lens 714 is activated by selection of a water management network icon 740 via the domain selection panel 736, and the lens 714 is overlaid on a region of the graphical overlay 700. In this example, regardless of the region on which the lens 714 is overlaid, the lens 714 (and thus the at least one first domain context) and the at least one second domain context are in a fully overlapping spatial relation to each other.

The at least one transportation domain context displayed throughout the entire graphical overlay 700 may be activated by default upon selection of a transportation network icon 738, or the at least one transportation domain context may be user-activated. Additionally, throughout the various embodiments described herein, one or more lenses can be activated by an external event trigger. Similarly, one or more domain contexts may be activated by an external event trigger such that an already active lens is populated with data and/or icons corresponding to the externally triggered domain context. Returning to FIG. 7, the visibility of water management domain contexts within the lens 714 is controlled by way of interactive icons 718, 722. Activation of at least one of the transportation domain contexts results in the at least one activated transportation domain context being displayed throughout the entire graphical overlay 700, as indicated by arrow 704, and activation of at least one of the water management domain contexts results in the at least one activated water management domain context being displayed within the lens 714, as indicated by arrow 726. By way of example, consider that both a road maintenance records/schedule context and a transportation alerts/warnings context are activated, resulting in icons 728 and 730 displayed within the graphical overlay 700. Also, consider that both the water pipe maintenance records/schedule context (represented by icon 718) and the water management alerts/warnings context (represented by icon 722) are activated, resulting in icons 732 and 734 displayed within the lens 714 on the graphical overlay 700. As a result of simultaneously displaying the fully overlapping at least one transportation domain context and the at least one water management domain context, which represent fully overlapping visual representations of both the transportation domain and water management domain semantic models, inferences regarding the cross-domain interactions between the transportation domain and the water management domain can be identified. Further, as a result of identifying such cross-domain interactions, well-informed decisions can be made regarding the management and operations of the affected domains within the city and/or region represented by the graphical overlay 700 (i.e., the operations environment).

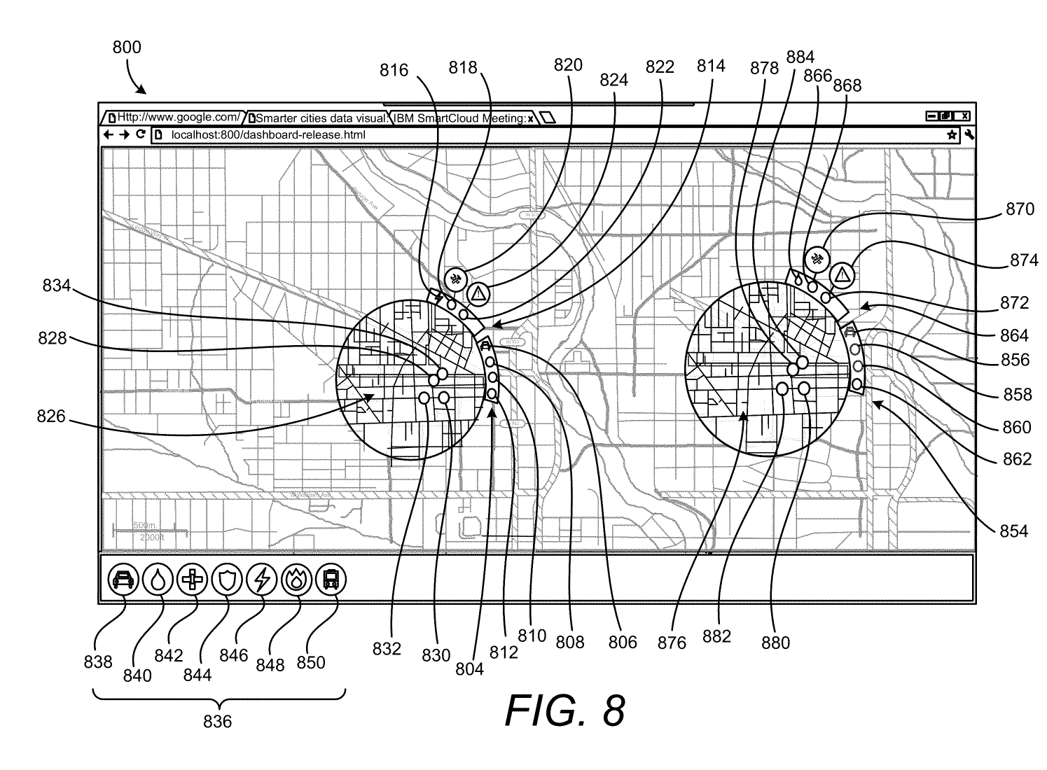

FIG. 8 is a graphical overlay illustrating a first set of lenses which includes a first lens 804 including at least one first domain context and a second lens 814 including at least one second domain context, in accordance with one embodiment. The graphical overlay 800 also illustrates a second set of lenses, which includes a third lens 854 including at least one third domain context, and a fourth lens 864 including at least one fourth domain context, in accordance with some embodiments. In the example of FIG. 8, the cross-domain operations center may receive reports of two separate regions reporting problems within the graphical overlay 800 and which require troubleshooting. For example, a first region, where the first set of lenses is overlaid, is reporting a power line down. Thus, the first lens 804 may correspond to a transportation network domain as indicated by icon 806 and the second lens 814 may correspond to an energy network domain as indicated by icon 816. The first lens 804 is activated by selection of a transportation network icon 838 via a domain selection panel 836 and overlaid on the first region of the graphical overlay 800. Similarly, the second lens 814 is activated by selection of an energy network icon 846 via the domain selection panel 836 and overlaid on the same region of the graphical overlay 800 as the first lens 804 such that the first lens 804 and the second lens 814 are in a fully overlapping spatial relation to each other. In other embodiments, as discussed above, the first lens 804 and the second lens 814 may be in one of a partially overlapping and non-overlapping spatial relation to each other.

Continuing with this example, a second region, where the second set of lenses is overlaid, is reporting an area of traffic congestion. Thus, the third lens 854 may correspond to a transportation network domain as indicated by icon 856 and the fourth lens 864 may correspond to a water management network domain as indicated by icon 866. The third lens 854 is activated by selection of the transportation network icon 838 via the domain selection panel 836 and overlaid on the second region of the graphical overlay 800. Similarly, the fourth lens 864 is activated by selection of a water management network icon 840 via the domain selection panel 836 and overlaid on the same region of the graphical overlay 800 as the third lens 854 such that the third lens 854 and the fourth lens 864 are in a fully overlapping spatial relation to each other. In other embodiments, as discussed above, the third lens 854 and the fourth lens 864 may be in one of a partially overlapping and non-overlapping spatial relation to each other.

Visibility of various transportation domain contexts within the first lens 804 is controlled by way of interactive icons 808, 810, 812, and visibility of energy network domain contexts within the lens 814 is controlled by way of interactive icons 818, 822. Activation of at least one of the transportation domain contexts within the first lens 804 results in the at least one activated transportation domain context being displayed within the first lens 804, as indicated by arrow 826, where elements of the transportation domain related to the at least one activated transportation domain context are highlighted within the area circumscribed by the first lens 804. Similarly, activation of at least one of the energy network domain contexts within the second lens 814 results in the at least one activated energy network domain context being displayed within the second lens 814, as indicated by arrow 826, where elements of the energy network domain related to the at least one activated energy network domain context are highlighted within the area circumscribed by the second lens 814. In some embodiments, upon activation of either of the first and second lenses 804, 814, at least one of a default transportation and energy network domain context is activated, and thus at least one context is activated within the first set of lenses. In other embodiments, upon activation of either of the first and second lenses 804, 814, no domain contexts are activated by default, and instead any activated contexts are user-activated.

In a similar manner, visibility of the various transportation domain contexts within the third lens 854 is controlled by way of interactive icons 858, 860, 862, and visibility of water management network domain contexts within the fourth lens 864 is controlled by way of interactive icons 868, 872. Activation of at least one of the transportation domain contexts within the third lens 854 results in the at least one activated transportation domain context being displayed within the third lens 854, as indicated by arrow 876, where elements of the transportation domain related to the at least one activated transportation domain context are highlighted within the area circumscribed by the third lens 854. Similarly, activation of at least one of the water management network domain contexts within the fourth lens 864 results in the at least one activated water management network domain context being displayed within the fourth lens 864, as indicated by arrow 876, where elements of the water management network domain related to the at least one activated water management network domain context are highlighted within the area circumscribed by the fourth lens 864. In some embodiments, upon activation of either of the third and fourth lenses 854, 864, at least one of a default transportation and water management network domain context is activated, and thus at least one context is activated within the second set of lenses. In other embodiments, upon activation of either of the third and fourth lenses 854, 864, no domain contexts are activated by default, and instead any activated contexts are user-activated.

Further, in some embodiments, activation of at least one context within each of the first and second set of lenses includes simultaneously displaying visual representations of disparate semantic models within each of the first and second set of lenses. In other embodiments, activation of at least one context within each of the first and second set of lenses includes simultaneously displaying visual representations of similar semantic models within each of the first and second set of lenses. In a further example, in some embodiments, at least one context within each of the first, second, third, and fourth lenses 804, 814, 854, 864 are activated, and visual representations of disparate semantic models are displayed within each of the first, second, third, and fourth lenses 804, 814, 854, 864. In other embodiments, at least two of the contexts displayed within the first, second, third, and fourth lenses 804, 814, 854, 864 are the same, and thus visual representations of similar semantic models are displayed within at least two of the first, second, third, and fourth lenses 804, 814, 854, 864. By simultaneously displaying the visual representations of the at least two semantic models within each of the first and second set of lenses, a cross-domain interaction between the at least two domains represented by the at least two semantic models within each of the first and second set of lenses can be identified based on visual patterns of semantic data.

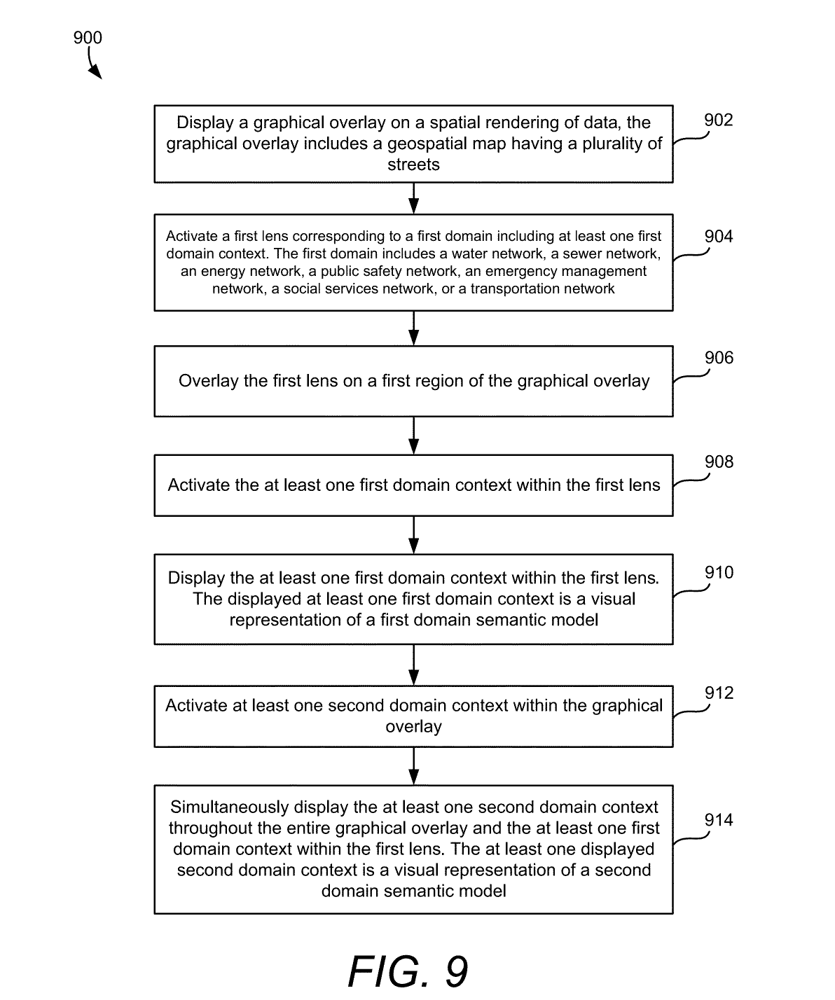

FIG. 9 is a flow chart illustrating the method for displaying at least one first domain context within a lens and at least one second domain context throughout an entire graphical overlay, in accordance with one embodiment. In the discussion of FIG. 9, reference is also made to elements described in FIG. 1 and FIG. 7. Computer implemented method 900 can be implemented in DPS 100 or in DPS 100 in conjunction with DPS 102 and network 141, for example, by providing computer program instructions to a processor of DPS 100 or DPS 102 for execution of the program instructions to perform functions related to the visualization of contextual semantic data within one or more lenses within a graphical overlay, as described herein with reference to the method 900.

Method 900 starts with the display of a graphical overlay, such as the graphical overlay 700 having a plurality of streets, on a spatial rendering of data (block 902). A first lens 714 corresponding to a first domain, and including at least one first domain context, is activated (block 904), for example, by selection of an appropriate icon via a domain selection panel 736, and the first lens 714 is overlaid on a first region of the graphical overlay 700 (block 906). In some embodiments, a default context for each lens is already active, thus no initial explicit context activation is necessary unless an alternative, non-default context, is required. In some embodiments, the first domain corresponds to one of a water network, a public safety network, a sewer network, a transportation network, a social services network, an emergency management network, and an energy network. The at least one first domain context is activated (block 908), for example, by way of interactive icons 718, 722. Activation of the at least one first domain context results in the at least one first domain context being displayed within the first lens 714 (block 910). Moreover, the displayed at least one first domain context is a visual representation of a first domain semantic model. At least one second domain context is activated (block 912), and the at least one second domain context is displayed throughout the entire graphical overlay 700 simultaneously to displaying the at least one first domain context within the first lens 714 (block 914). Furthermore, the displayed at least one second domain context is a visual representation of a second domain semantic model. In the method 900, regardless of the region on which the first lens 714 is overlaid, the first lens 714 (and thus the at least one first domain context) and the at least one second domain context are in a fully overlapping spatial relation to each other.

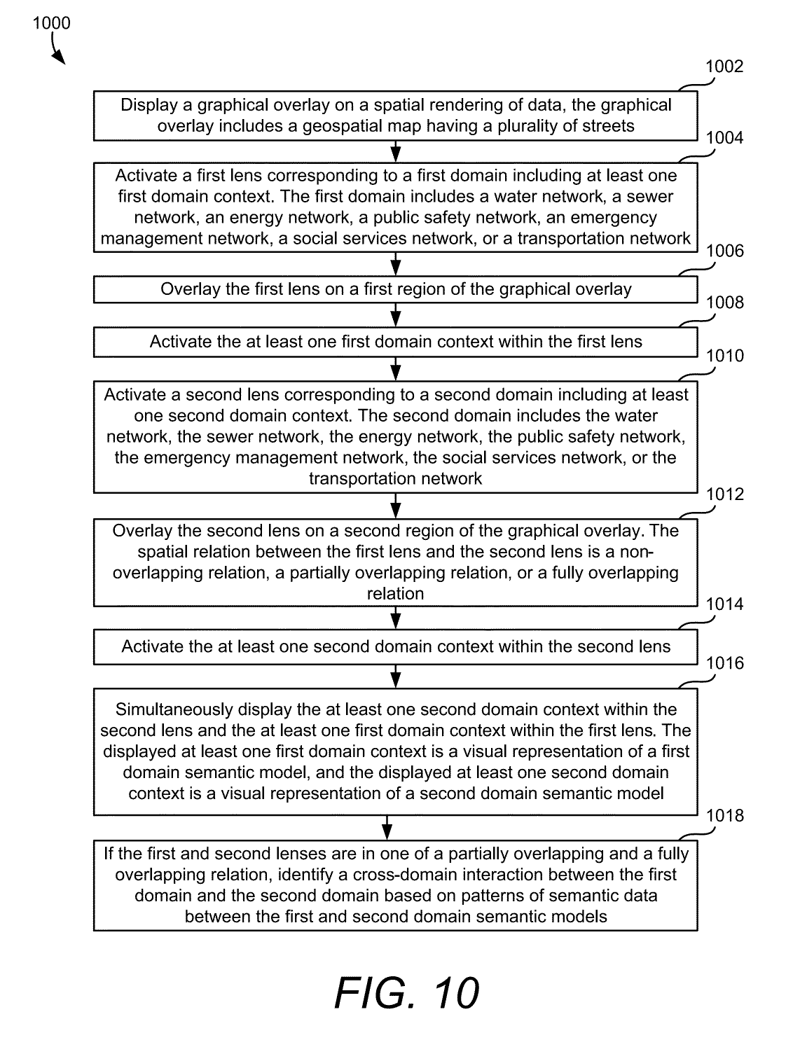

FIG. 10 is a flow chart illustrating the method for displaying at least one first domain context within a first lens and at least one second domain context within a second lens, in accordance with one embodiment. In the discussion of FIG. 10, reference is also made to elements described in FIG. 1 and FIG. 4. Computer implemented method 1000 can be implemented in DPS 100, for example, by providing computer program instructions to a processor of DPS 100 for execution of the program instructions to perform functions related to the visualization of contextual semantic data within one or more lenses within a graphical overlay, as described herein with reference to the method 1000.

Method 1000 starts with the display of a graphical overlay, such as the graphical overlay 400 having a plurality of streets, on a spatial rendering of data (block 1002). A first lens 404 corresponding to a first domain, and including at least one first domain context, is activated (block 1004), for example, by selection of an appropriate icon via a domain selection panel 436, and the first lens 404 is overlaid on a first region of the graphical overlay 400 (block 1006). In some embodiments, the first domain corresponds to one of a water network, a public safety network, a sewer network, a transportation network, a social services network, an emergency management network, and an energy network. The at least one first domain context is activated (block 1008), for example, by way of interactive icons 408, 410, 412. A second lens 414 corresponding to a second domain, and including at least one second domain context, is activated (block 1010), for example, by selection of an appropriate icon via a domain selection panel 436, and the second lens 414 is overlaid on a second region of the graphical overlay 400 (block 1012). In some embodiments, the second domain corresponds to one of a water network, a public safety network, a sewer network, a transportation network, a social services network, an emergency management network, and an energy network. In various embodiments, the spatial relation between the first and second lenses 404, 414 includes one of a non-overlapping relation, a partially overlapping relation, and a fully overlapping relation. The at least one second domain context is activated (block 1014), for example, by way of interactive icons 418, 422. The at least one second domain context is displayed within the second lens 414 simultaneous to displaying the at least one first domain context within the first lens 404 (block 1016). Moreover, the displayed at least one first domain context is a visual representation of a first domain semantic model, and the displayed at least one second domain context is a visual representation of a second domain semantic model. By simultaneously displaying the visual representations of the first and second domain semantic models, a cross-domain interaction between the first domain and the second domain can be identified based on visual patterns of semantic data between the first and second domain semantic models (block 1018). As a result of identifying such cross-domain interactions, well-informed decisions can be made regarding the management and operations of the affected domains within the city and/or region represented by the graphical overlay 400 (i.e., the operations environment).

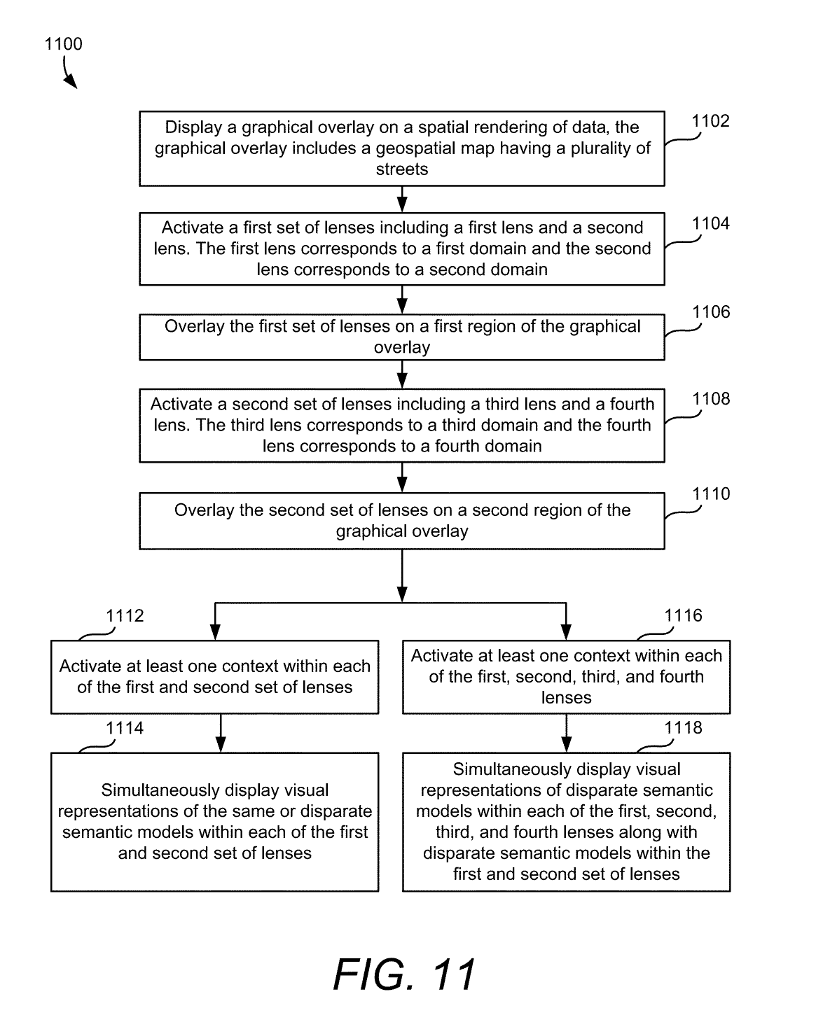

FIG. 11 is a flow chart illustrating the method for displaying at least one first domain context within a first set of lenses and at least one second domain context within a second set of lenses, in accordance with various embodiments. In the discussion of FIG. 11, reference is also made to elements described in FIG. 1 and FIG. 8. Computer implemented method 1100 can be implemented in DPS 100 or in DPS 100 in conjunction with DPS 102 and network 141, for example, by providing computer program instructions to a processor of DPS 100 or DPS 102 for execution of the program instructions to perform functions related to the visualization of contextual semantic data within one or more lenses within a graphical overlay, as described herein with reference to the method 1100.

Method 1100 starts with the display of a graphical overlay, such as the graphical overlay 800 having a plurality of streets, on a spatial rendering of data (block 1102). A first set of lenses which includes a first lens 804 corresponding to a first domain and a second lens 814 corresponding to a second domain, is activated (block 1104), and the first set of lenses 804, 814 is overlaid on a first region of the graphical overlay 800 (block 1106). In some embodiments, the first lens 804 includes at least one first domain context and the second lens 814 includes at least one second domain context. A second set of lenses which includes a third lens 854 corresponding to a third domain and a fourth lens 864 corresponding to a fourth domain, is activated (block 1108), and the second set of lenses 854, 864 is overlaid on a second region of the graphical overlay 800 (block 1110). In some embodiments, the third lens 854 includes at least one third domain context and the fourth lens 864 includes at least one fourth domain context.

Thereafter, in some embodiments, at least one context within each of the first and second set of lenses is activated (block 1112), and visual representations of disparate and/or similar semantic models within each of the first and second set of lenses are simultaneously displayed (block 1114). Alternatively, in other embodiments, at least one context within each of the first, second, third, and fourth lenses 804, 814, 854, 864 are activated (block 1116), and visual representations of disparate semantic models are displayed within each of the first, second, third, and fourth lenses 804, 814, 854, 864, along with disparate semantic models within the first and second set of lenses (block 1118). In some exemplary embodiments, where at least one context within each of the first, second, third, and fourth lenses 804, 814, 854, 864 are activated (block 1116), at least two of the contexts displayed within the first, second, third, and fourth lenses 804, 814, 854, 864 may be the same.

In each of the flow charts above, one or more of the methods may be embodied in a computer readable medium containing computer readable code such that a series of steps are performed when the computer readable code is executed on a computing device. In some implementations, certain steps of the methods are combined, performed simultaneously or in a different order, or perhaps omitted, without deviating from the spirit and scope of the disclosure. Thus, while the method steps are described and illustrated in a particular sequence, use of a specific sequence of steps is not meant to imply any limitations on the disclosure. Changes may be made with regards to the sequence of steps without departing from the spirit or scope of the present disclosure. Use of a particular sequence is therefore, not to be taken in a limiting sense, and the scope of the present disclosure is defined only by the appended claims.

As will be appreciated by one skilled in the art, aspects of the present disclosure may be embodied as a system, method or computer program product. Accordingly, aspects of the present disclosure may take the form of an entirely hardware embodiment or an embodiment combining software (including, for example, firmware, resident software, micro-code, etc.) and hardware aspects that may all generally be referred to herein as a “circuit,” “module” or “system.” Furthermore, aspects of the present disclosure may take the form of a computer program product embodied in one or more computer readable storage devices or other computer readable medium(s) having computer readable program code embodied thereon.

Any combination of one or more computer readable medium(s) may be utilized. The computer readable medium may be a computer readable signal medium or a computer readable storage device. A computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage device and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, R.F, etc., or any suitable combination of the foregoing. Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions can configure a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The article of manufacture containing the programming code is used by either executing the code directly from the storage device, by copying the code from the storage device into another storage device such as a hard disk, RAM, etc., or by transmitting the code for remote execution using transmission type media such as digital and analog communication links. The methods of the disclosure may be practiced by combining one or more machine-readable storage devices containing the code according to the present disclosure with appropriate processing hardware to execute the code contained therein. An apparatus for practicing the disclosure could be one or more processing devices and storage systems containing or having network access to program(s) coded in accordance with the disclosure.

Thus, it is important that while an illustrative embodiment of the present disclosure is described in the context of a fully functional computer (server) system with installed (or executed) software, those skilled in the art will appreciate that the software aspects of an illustrative embodiment of the present disclosure are capable of being distributed as a program product in a variety of forms, and that an illustrative embodiment of the present disclosure applies equally regardless of the particular type of media used to actually carry out the distribution.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

While particular embodiments of the present disclosure have been shown and described, it will be obvious to those skilled in the art that, based upon the teachings herein, changes and modifications may be made without departing from this disclosure and its broader aspects. Consequently, the appended claims are to encompass within their scope all such changes and modifications as are within the true spirit and scope of this disclosure and embodiments of the disclosure are intended to be limited only by the scope of the appended claims, giving full cognizance to equivalents in all respects.

1-11. (canceled)

12. A data processing system comprising:
at least one storage device having a set of instructions located therein; and
at least one processor in communication with the at least one storage device, the at least one processor operable to execute the set of instructions which cause the at least one processor to:
display a graphical overlay on a spatial rendering of data;
activate a first lens corresponding to a first domain, wherein the first domain includes at least one first domain context;
overlay the first lens on a first region of the graphical overlay;
activate the at least one first domain context within the first lens; and
responsive to the activation of the at least one first domain context within the first lens, display the at least one first domain context within the first lens, wherein the at least one displayed first domain context is a visual representation of a first domain semantic model.

13. The data processing system of claim 12, further comprising instructions that cause the processor to:
activate at least one second domain context within the graphical overlay; and
in response to the activation of the at least one second domain context, simultaneously display the at least one second domain context throughout the entire graphical overlay and the at least one first domain context within the first lens, wherein the at least one displayed second domain context is a visual representation of a second domain semantic model.

14. The data processing system of claim 12, further comprising instructions that cause the processor to:
activate a second lens corresponding to a second domain, wherein the second domain includes at least one second domain context;
overlay the second lens on a second region of the graphical overlay;
activate the at least one second domain context within the second lens; and
responsive to the activation of the at least one second domain context within the second lens, simultaneously display the at least one second domain context within the second lens and the at least one first domain context within the first lens, wherein the at least one displayed second domain context is a visual representation of a second domain semantic model.

15. The data processing system of claim 12, further comprising instructions that cause the processor to:
activate a first set of lenses comprising the first lens and a second lens corresponding to a second domain;
overlay the first set of lenses on the first region of the graphical overlay;
activate a second set of lenses comprising a third lens corresponding to a third domain and a fourth lens corresponding to a fourth domain;
overlay the second set of lenses on a second region of the graphical overlay;
activate at least one context within each of the first and second set of lenses; and
responsive to the activation of the at least context within each of the first and second set of lenses, simultaneously display visual representations of disparate semantic models within each of the first and second set of lenses.

16. The data processing system of claim 15, further comprising instructions that cause the processor to:
activate at least one context within each of the first, second, third, and fourth lenses; and
responsive to the activation of the at least context within each of the first, second, third, and fourth lenses, simultaneously display visual representations of disparate semantic models within each of the first, second, third, and fourth lenses.

17. The data processing system of claim 12, further comprising instructions that cause the processor to:
activate a first set of lenses comprising the first lens and a second lens corresponding to a second domain;
overlay the first set of lenses on the first region of the graphical overlay;
activate a second set of lenses comprising at least one of the first lens and the second lens;
overlay the second set of lenses on a second region of the graphical overlay;
activate at least one context within each of the first and second set of lenses; and
responsive to the activation of the at least one context within each of the first and second set of lenses, simultaneously display visual representations of similar semantic models within each of the first and second set of lenses.

18. A computer program product comprising:
a computer readable storage device; and
program code on the computer readable storage device that when executed within a data processing device, the program code provides the functionality of:
displaying a geospatial map on a spatial rendering of data;
activating a first lens corresponding to a first domain, wherein the first domain includes at least one first domain context;
overlaying the first lens on a first region of the geospatial map;
activating the at least one first domain context within the first lens; and
responsive to activating the at least one first domain context within the first lens, displaying the at least one first domain context within the first lens, wherein the at least one displayed first domain context is a visual representation of a first domain semantic model.

19. The computer program product of claim 18, further comprising program code that when executed within the data processing device, the program code provides the functionality of:
activating at least one second domain context within the geospatial map; and
in response to activating the at least one second domain context, simultaneously displaying the at least one second domain context throughout the entire geospatial map and the at least one first domain context within the first lens, wherein the at least one displayed second domain context is a visual representation of a second domain semantic model.

20. The computer program product of claim 18, further comprising program code that when executed within the data processing device, the program code provides the functionality of:
activating a second lens corresponding to a second domain, wherein the second domain includes at least one second domain context;
overlaying the second lens on a second region of the geospatial map;
activating the at least one second domain context within the second lens; and
responsive to activating the at least one second domain context within the second lens, simultaneously displaying the at least one second domain context within the second lens and the at least one first domain context within the first lens, wherein the at least one displayed second domain context is a visual representation of a second domain semantic model.
